(19) United States
(12) Patent Application Publication
(10) Pub. No.: US 2013/0212898 A1
(43) Pub. Date: Aug. 22, 2013

(54) Golfing accessory for drying golf gloves

(71) Applicant: Chris Reynolds, Boca Raton, FL (US)

(72) Inventor: Chris Reynolds, Boca Raton, FL (US)

(21) Appl. No.: 13/402,542

(22) Filed: Feb. 22, 2012

(51) Int. Cl. F26B 25/00

(52) U.S. Cl. 34/239

(57) ABSTRACT

A golfing accessory for attachment to a golf bag for drying a plurality of golf gloves. The golfing accessory includes a flexible strap that includes a plurality of spring loaded clips to securely hold the golf gloves to the accessory and facilitate the drying process. The flexible strap also includes a snap lock fastener and a ring that enables the accessory to be attached to a golf bag and a second golf accessory to increase the drying capacity of the accessory. The golf accessory further incorporates an appealing display area that is suitably large and easily viewable, such that a product or service logo or name, or the owner's name or initials can be attractively displayed.

### FIELD OF THE INVENTION

The invention is a golfing accessory that is designed to secure a plurality of golf gloves to a golf bag so that the gloves can air dry in between usage by the golfer. The invention provides ease of use, easy access to any one of the plurality of gloves and in addition provides a very secure attachment of the accessory to the golf bag such that the gloves will not come off during transportation or storage.

### BACKGROUND OF THE INVENTION

The present invention relates to a golfing accessory configured to be easily attached and removed from a golf bag. The plurality of gloves are securely supported on the golfing accessory so that they may be air dried between usages by the golfer. A plurality of golf accessories can be coupled together to increase the number of gloves that can be dried simultaneously. The accessory is also configured in such a way so as to display indicia relating to the owner of the golf bag, a golf course, country club, a manufacturer's branding logo or other indicia.

When playing a round or two of golf it most often necessary for the golfers to remove and replace their golf gloves due to the amount of perspiration generated by their hands. In fact it is not uncommon for golfers, particularly in warm and humid climates, to change their gloves three or more times during a single round of golf. Typically, a golfer may remove their water saturated glove and place it within a plastic lined container located within the golf bag that is intended to hold liquid refreshment. However, when stored in this container the glove or gloves will not dry quickly enough to be used even within the next few days. Other options include stuffing in one's pants pocket, or somehow attach them to one or more structural elements located within one's golf cart. These solutions do not permit the gloves to dry rapidly, they are unsightly, and they can result in the glove or gloves being misplaced or lost as a result of not being securely attached to a mounting strap in an organized fashion.

### Description of the Prior Art

In the past a number of attempts have been made to solve these difficulties. The following is a description of these attempts. One type of design includes U.S. Publication No. 2007/0075106, to Meeh, that discloses a golf accessory having a spring biased cord, within a housing, which when extended, exposes one or more clamps, for use for holding golf gloves or other golf accessories in place. A locking switch provides for fixing of the cord to the extent that it has been withdrawn from its housing, and the locking switch may be released, for allowing the cord to be drawn under the biased of spring pressure back into the housing, as during non-usage. The outer end of the cord may include a strip of Velcro, and may have a weighted member provided at its end, to allow for suspension of the cord from the golf bag and readily exposed for holding golf accessories, such as golf gloves, in place, during non-usage.

Another arrangement, shown in U.S. Publication No. 2011/0035911, to Carnate, which uses a holder for securing a glove or other article to a bag, hook or other item. The holder includes a ring, a snap hook type fastener attached to the ring in swivel fashion, and a rigid or semi-rigid tag suspended from the ring by a strap. In one embodiment the tag has two members or halves hingedly connected to each other in clamshell fashion so that the two members can be folded together held together via hook and loop type fasteners. The glove may be secured to the holder with a hook and loop type fastening surface located on the glove. The holder can also secure an article not having a hook or loop type fastening surface by draping the article over the hinge.

U.S. Pat. No. 7,886,945, to Fitzgerald et al, discloses a garment hanger comprised of a header card and a clamp, the header card being preferably “free-floating” relative to the clamp to give a prospective purchaser a sense that the clamp is attached more to the garment than to the header card and that the card is thus disposable after purchase. In one embodiment, a hanger for displaying and holding an article such as a pair of gloves comprises a clothespin-like clamp comprising a pair of jaws resiliently biased about a pivot region to a closed, article-holding position, and a header defining an opening for receiving the pivot region of the clamp. Preferably, the opening in the header is larger than the pivot region of the clamp so as to provide for relative movement between the clamp and the header.

U.S. Pat. No. 5,177,881, to Moore, discloses a golfing accessory capable of being attached to the exterior of a golf bag that has a plate-like portion providing space for the name of the golfer and the logo of a particular golf course or golfing event. The plate-like element is attached to a first strap attached to the bag. A second strap hangs from the plate-like portion and contains a fastener thereon for detachably securing a golf glove for the purpose of drying the glove. A hook may also be provided on the first strap for hanging a golfing towel.

U.S. Pat. No. 5,864,925, to McGee, discloses a thin plastic card, with Velcro patches on the front and back, and is connected to a spring-loaded reel mechanism which contains a retractable cord. The reel mechanism is attached to the person. The plastic card is then extended by pulling on the retractable cord in of the reel mechanism. When fully extended, the Velcro on the glove is mated and attached to the corresponding Velcro on the plastic card.

U.S. Pat. No. 5,795,248, to Giglio, discloses a golf accessory caddy having a body member having a substantially cylindrical shaped ball marker storage cavity formed therein. The body member further having an access opening defined by a first surface thereof; a flat, semi-circular shaped ball marker retaining magnet positioned within the ball marker storage cavity; a clip member extending from the body member, the clip member defining an insertion slot between the clip member and the body member; and a glove attachment surface covering at least a portion of the first surface having a plurality of members attachable to one of the hook and pile fastener surfaces of an existing golf glove. In one embodiment, a ball marker is provided that is sized to fit within the ball marker storage cavity and that includes a sufficient quantity of magnetically attractable material to allow the ball marker to be held within the ball marker storage cavity by contact with the ball marker retaining magnet. The ball marker is preferably disk shaped and sized such that at least a portion of the ball marker extends over the ball marker retaining magnet when the ball marker completely covers the ball marker retaining magnet.

U.S. Pat. No. 4,625,862, to Clayton, discloses an accessory support assembly for use with golf bags, belts, garment loops and the like comprising a first component having a Velcro section, said component being suspended from said golf bag or other article, a second component carrying a Velcro section adapted for interengagement with the Velcro section on the first component, said second component being engaged to a frequently used accessory whereby the latter is maintained against loss during disuse by engagement of the Velcro sections on said first and second components.

Ellenburg, U.S. Pat. No. 5,983,518, discloses a golf glove drying attachment for a golf cart or a golf bag, intended to improve air circulation through the glove while the user is on the golf course. The glove drying attachment includes a slightly tapered shell for holding the glove, and a clamp for attaching to a golf cart. As the golf cart is driven, wind from the golf cart dries the glove. Alternatively, the shell may include a battery powered fan, and attach to a golf bag.

### SUMMARY OF THE INVENTION

The present invention is directed to a golf accessory that will enable the golfer to quickly and easily access a fresh golf glove. A single golf glove accessory has the capacity to securely hold and air dry a plurality of golf gloves. Additional golf accessories can be coupled to one another to further increase the storing and drying capacity of the golf accessory. The components of the golf accessory are durable and easy to assemble. The golf accessory includes an easy to use clip to facilitate attachment to a loop typically found on the outside of a conventional golf bag. The golf accessory further incorporates an appealing display area that is suitably large and easily viewable such that a product logo, the owner's name or initials, a course or country club name, or a golfing event can be attractively displayed.

The present invention provides many advantages over the prior art by providing a golf accessory that will easily and securely support a plurality of golf gloves.

Accordingly, it is a primary objective of the instant invention to provide an inexpensive and reliable golf accessory for simultaneously drying a plurality of gloves.

It is a further objective of the instant invention that it is easily attached and removed from a golf bag.

It is yet another objective of the instant invention to provide a golf accessory dryer wherein two or more golf dryer accessories can be supported by one another to the golf bag.

It is a still further objective of the invention to provide a golf accessory that provides an attractive and easily viewable display for indicia, pertaining to the individual, or product or service branding.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a perspective view of the golf accessory for drying gloves

FIG. 2 is a side view of the golf accessory.

FIG. 3 is a top view of the golf accessory.

FIG. 4 is a bottom view of the golf accessory.

FIG. 5 is a view showing two golf accessories with one coupled to the other.

FIG. 6 shows the golf accessory attached to a golf bag.

### DETAILED DESCRIPTION OF THE INVENTION

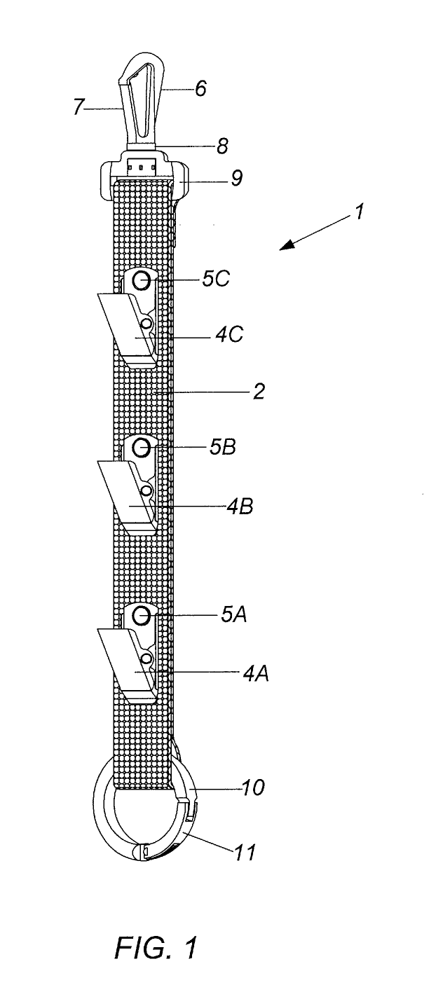

FIG. 1 is a perspective view of the golf accessory (1). As shown, it includes a flexible strap (2) made from a nylon material or any other suitable synthetic or natural material and further includes three separate spring loaded clips (4A), (4B) and (4C) attached to the flexible strap (2) by fasteners (5A), (5B) and (5C), respectively. It should be understood that, while three spring loaded clips are preferred, it is possible to use fewer spring loaded clips or more than three spring loaded clips per strap. The length of the flexible strap (2) in its assembled condition would be in the range of two to six inches, and preferably in the three to five inch range. Dependent upon the length of the strap, it could have as few as two spring loaded clips and as many as seven. The fasteners (5A), (5B) and (5C) are in the form of rivets that are made from metallic or synthetic material. A snap hook type fastener (6), formed from either synthetic or metallic material, is attached at a first end of the flexible strap (2). The snap hook type fastener (6) includes a resilient tang (7) that is biased to a closing position and will open upon the exertion of force thereon. The snap hook type fastener (6) is mounted to a generally rectangular loop (9) with a swivel coupling (8) that allows 360 degree rotation of the snap hook type fastener (6) relative to the generally rectangular loop (9). A generally circular ring (10) is attached to a second end of the flexible strap (2). The generally circular ring (10) may include a pivotable arcuate section (11) that will permit the ring to open. Alternatively the circular ring (10) can be formed as a fixed ring.

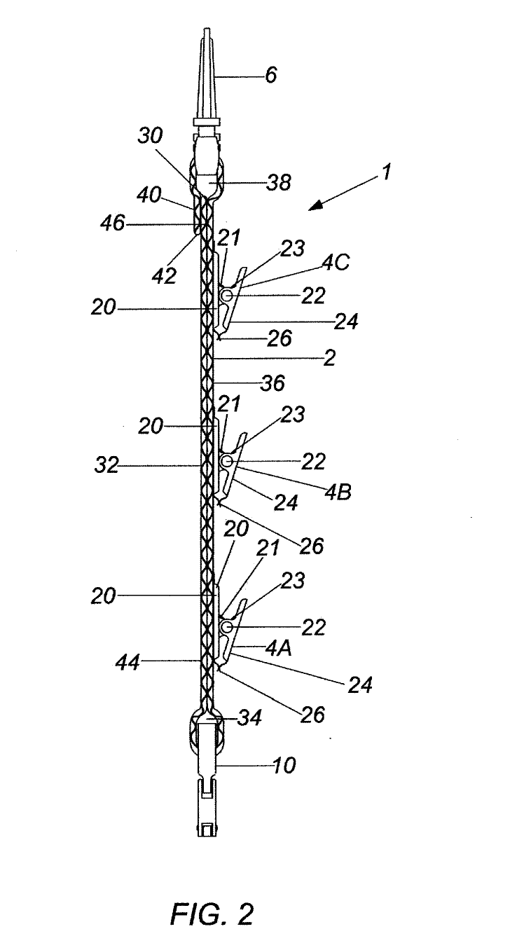

FIG. 2 is a side view of the golf accessory (1). As shown flexible strap (2) has a plurality of spring loaded clips (4A), (4B), and (4C) mounted thereon with snap hook type fastener (6) attached to a first end and a circular ring (10) attached to a second end. Each spring loaded clip (4A), (4B), and (4C) includes a base portion (20) with an aperture to receive a fastener (5A), (5B) and (5C), respectively. Each base portion (20) includes a pair of upstanding arms each having an aperture to receive a pivot rod (22). Each spring loaded clip (4A), (4B), and (4C) further includes a moveable arm (24) each having a pair of upstanding arms each having an aperture to also receive that pivot rod (22). The pivot rod (22) supports a resilient element to bias the moveable arm (24) into contact with the base portion (20). The resilient member can take the form of a coiled spring wrapped about the pivot rod (22) and having one end (21) that is generally straight bearing against the base portion (20) and the other end (23) of the spring being generally straight and bearing against the moveable arm (24). The spring loaded clips (4A), (4B), and (4C) are biased to the closed position as shown at the point of gripping (26) where the moveable arm (24) and the base portion (20) are urged into contact with one another. The flexible strap (2) is made from one piece of elongated generally rectangular material. The flexible strap (2) has a first end (30) and a first layer (32). The flexible strap (2) is then turned over upon itself allowing forming a first pocket (34). Thereafter the flexible strap (2) is placed over the first layer (32) creating a second layer (36). The flexible strap (2) in then turned back again forming a second pocket (38) and thereafter forming a partial third layer (40) and terminating in a second end (42). The first pocket (34) is formed by affixing the first layer (32) to the second layer (36) at a first location (44) between the first pocket (34) and first spring loaded clip (4A). The first layer (32) and second layer (36) can be affixed by stitching, sonic welding, gluing or any other suitable mechanical fastener. Likewise, the second pocket (38) is formed by affixing the first layer (32) to the second layer (36) and the third layer (40) at a second location (46) located between the second pocket (38) and the spring loaded clip (4C) by stitching, sonic welding, by gluing or any other suitable mechanical fastener.

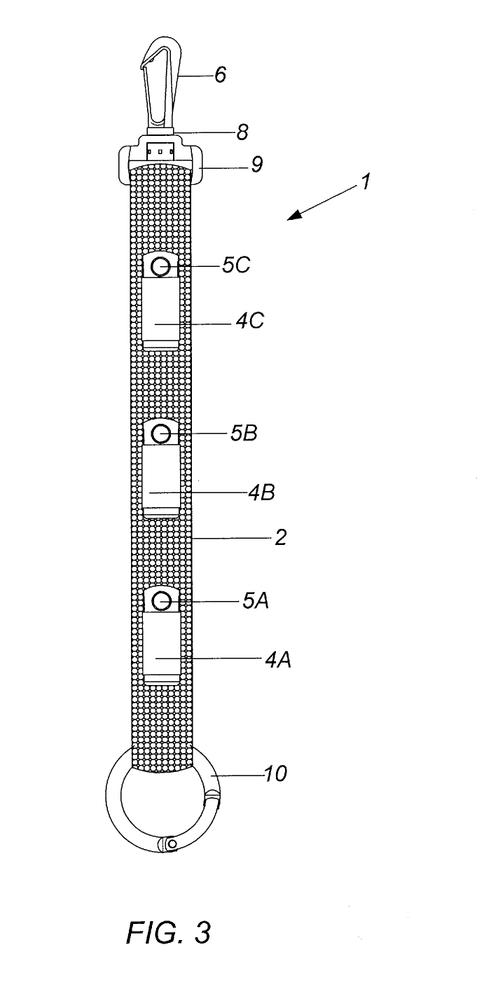

FIG. 3 is a top view of the golf accessory (1). As shown in this figure the golf accessory (1) includes a flexible strap (2) with three spring loaded clips (4A), (4B), and (4C) attached to flexible strap (2) by fasteners (5A), (5B) and (5C), respectively. A snap type hook fastener (6) is mounted via a swivel coupling (8) that is mounted on rectangular loop (9). The rectangular loop (9) is located between the first layer (32), the second layer (36), and the third layer (40) of the flexible strap (2) before the second pocket (38) is formed and the three layers are affixed to one another at second location (46). Likewise, the circular ring (10) is positioned between the first layer (32) and the second layer (36) of the flexible strap (2) before the first pocket (34) is formed and the first and second layers are affixed to one another at location (44).

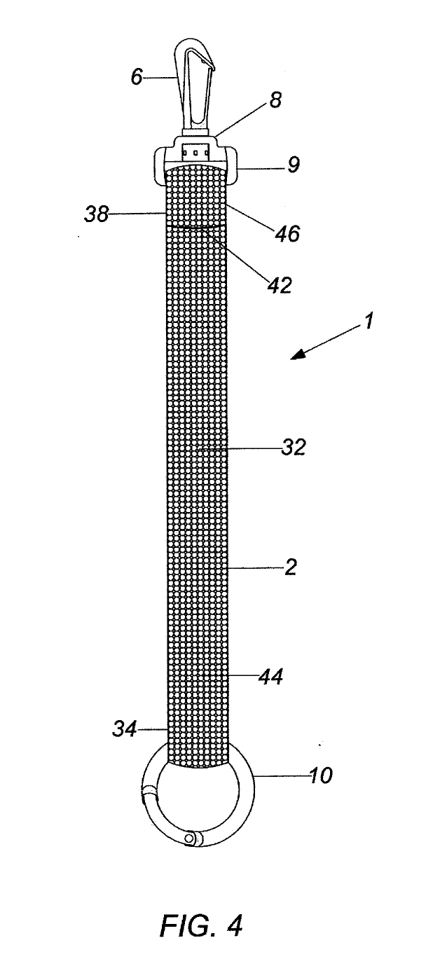

FIG. 4 is a bottom view of the golf accessory (1). As shown therein, the golf accessory (1) includes a flexible strap (2) with a snap hook type fastener (6) mounted on a swivel coupling (8) which in turn is mounted on a rectangular loop (9) that is positioned within a second pocket (38). The three layers of flexible strap (2) are affixed to one another at second location (46). The second end (42) of flexible strap (2) is located beneath second location (46). The first layer (32) of flexible strap (2) is visible in this view. The circular ring (10) is positioned with the first pocket (34). The first layer (32) and second layer (36) of flexible strap (2) are affixed to one another at first location (44). The space on first layer (32) of flexible strap (2) between first location (44) and second location (46) provides a surface to which various forms of indicia can be displayed. The indicia may be directly imprinted or embroidered thereon. Alternatively, the indicia can be placed on an adhesive film that is subsequently affixed to the first layer (32) or the indicia can be located on a plate or placard of any suitable material that is mechanically attached to the first layer (32) by adhesive or mechanical fasteners. The indicia could identify the owner of the bag, and/or the golf course or golfing event, or a product or service name or logo, by way of example.

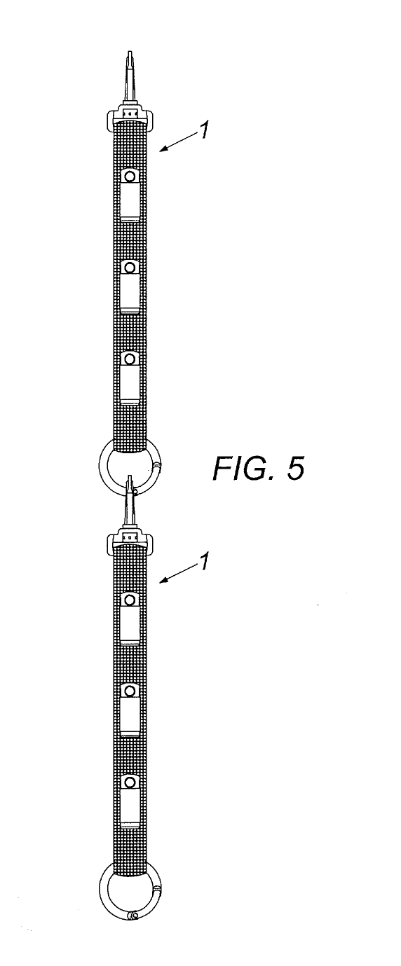

FIG. 5 is a view showing two golf accessories (1) with one coupled to the other.

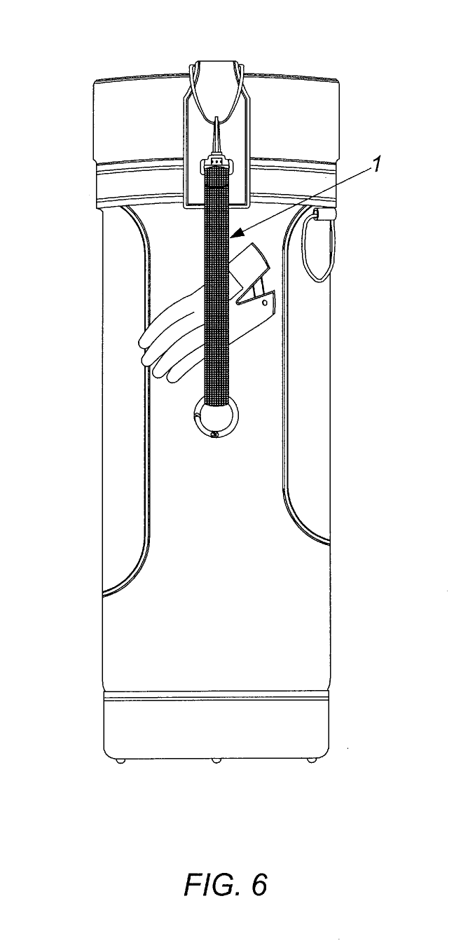

FIG. 6 shows the golf accessory (1) with a golf glove attached that is secured to a golf bag.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A golfing accessory for drying golf gloves configured to operatively engage a golf bag comprising:
a flexible strap having first and second ends and a top and bottom surface;
a snap hook type fastener being attached to the first end and a ring attached to the second end;
a plurality of spring loaded clips being attached to said top surface of said flexible strap between said first and second ends, each of said spring loaded clips being configured to hold a glove;
a display area located on the bottom surface of said strap capable of containing written matter, thereby identifying the owner of a golf bag, and or the golf course or golfing event, or a product or service name or logo.

2. The golfing accessory for drying golf gloves as set forth in claim 1, wherein the snap fastener includes a resilient tang that is biased to a closed position that will open upon the exertion of force thereon.

3. The golfing accessory for drying golf gloves as set forth in claim 2, wherein the snap hook type fastener is mounted to a loop with a swivel coupling that allows 360 degree rotation of the snap hook type fastener relative to the loop.

4. The golfing accessory for drying golf gloves as set forth in claim 1, wherein said ring includes a pivotable arcuate section that will permit the ring to open.

5. The golfing accessory for drying golf gloves as set forth in claim 1, wherein each of said spring loaded clips has a base portion with an aperture to receive a fastener to attach each of said spring loaded clips to said flexible strap and a moveable arm.

6. The golfing accessory for drying golf gloves as set forth in claim 5, wherein each base further includes a pair of upstanding arms, each of said upstanding base arms supporting a pivot rod, and said moveable arm having a pair of upstanding arms supporting said pivot rod.

7. The golfing accessory for drying golf gloves as set forth in claim 6, wherein the pivot rod supports a resilient member to bias the moveable arm into contact with the base.

8. The golfing accessory for drying golf gloves as set forth in claim 1, wherein the strap is turned over upon itself thereby creating a first and second pocket at the first and second end of the accessory.

9. The golfing accessory for drying golf gloves as set forth in claim 8, wherein the ring is positioned in the first pocket and the loop connected to the snap hook fastener is positioned in the second pocket.

10. The golfing accessory for drying golf gloves as set forth in claim 1, wherein said display area is configured to accept indicia that is imprinted or embroidered directly thereon.

11. The golfing accessory for drying golf gloves as set forth in claim 1, wherein said display area is configured to accommodate indicia that is imprinted on a discrete surface that is subsequently attached to said flexible strap.
